(19) United States
(12) Patent Application Publication
(10) Pub. No.: US 2025/0141063 A1
(43) Pub. Date: May 1, 2025

(54) BATTERY CELL CURRENT COLLECTOR TABS HAVING FEATURES TO FACILITATE ELECTRICAL CONNECTIONS

(71) Applicant: GM Global Technology Operations LLC, Detroit, MI (US)

(72) Inventors: Matthew Arthur Celentano, Royal Oak, MI (US); Hwanchul Kim, Dryden, MI (US); Vincent Edward Herrman, Clawson, MI (US); Subrahmanyam Goriparti, Troy, MI (US); John Christian Kalil, Washington, MI (US)

(21) Appl. No.: 18/499,539

(22) Filed: Nov. 1, 2023

(51) Int. Cl. H01M 50/54; H01M 4/04; H01M 50/536

(52) U.S. Cl. CPC H01M 50/54; H01M 4/04; H01M 50/536; H01M 2220/20

(57) ABSTRACT

A battery cell includes a housing enclosing an anode and a cathode, and an electrode assembly disposed in the housing, the electrode assembly including a plurality of electrode layers, each of the plurality of electrode layers having a respective tab configured to electrically connect the plurality of electrode layers to one another. A first electrode layer includes a first tab, the first tab being offset from another tab of another electrode layer.

### INTRODUCTION

The subject disclosure relates to batteries, and more particularly to manufacture and assembly of battery cells.

Battery cells are used in various applications, such as automotive applications (e.g., in electric and hybrid vehicles). For example, electric and hybrid vehicle battery systems include battery modules having multiple battery cells. Battery cells may be pouch-type cells, prismatic cells or other types of cells, and typically include multiple layers of both anode material and cathode material. Anode layers are electrically connected by welding a stack of anode tabs, and cathode layer are electrically connected by welding a stack of cathode tabs.

### SUMMARY

In one exemplary embodiment, a battery cell includes a housing enclosing an anode and a cathode, and an electrode assembly disposed in the housing, the electrode assembly including a plurality of electrode layers, each of the plurality of electrode layers having a respective tab configured to electrically connect the plurality of electrode layers to one another. A first electrode layer includes a first tab, the first tab being offset from another tab of another electrode layer.

In addition to one or more of the features described herein, the electrode assembly includes at least one of a plurality of anode layers and a plurality of cathode layers. Each of the plurality of anode layers has a respective anode tab configured to electrically connect the plurality of anode layers to one another, where a first anode layer includes a first anode tab, the first anode tab being offset from another anode tab of another anode layer. Each of the plurality of cathode layers has a respective cathode tab configured to electrically connect the plurality of cathode layers to one another, where a first cathode layer includes a first cathode tab, the first cathode tab being offset from another cathode tab of another cathode layer.

In addition to one or more of the features described herein, the first electrode layer is a first subset of the plurality of electrode layers, the first subset having a first group of tabs, and the another electrode layer is a second subset of the plurality of electrode layers, the second subset having a second group of tabs, where the first group of tabs is offset from the second group of tabs.

In addition to one or more of the features described herein, the first group of tabs and the second group of tabs each define an individual tab stack, each individual tab stack configured to be welded together by a single weld.

In addition to one or more of the features described herein, the respective tabs of the plurality of electrode layers are arranged in an alternating pattern.

In addition to one or more of the features described herein, the first tab overlaps the another tab.

In addition to one or more of the features described herein, the first tab and the another tab are part of a group of tabs, each of the group of tabs successively offset to form a continuous tab.

In addition to one or more of the features described herein, the first tab is offset by forming the first tab so that the first tab is located at a first distance from a side of the first tab, and the another tab is located at a second distance from a side of the another tab, the first distance being different than the second distance.

In addition to one or more of the features described herein, the battery cell is configured to be installed in a battery assembly having a plurality of battery cells.

In addition to one or more of the features described herein, the battery assembly is configured to be disposed in a vehicle to supply power for propulsion of the vehicle.

In another exemplary embodiment, a method of manufacturing a battery cell includes acquiring an electrode material, and creating a plurality of electrode layers from the electrode material, wherein the creating includes forming a respective tab for each electrode layer, where a first electrode layer is formed with a first tab, the first tab being offset from another tab of another electrode layer. The method also includes electrically connecting the plurality of electrode layers by welding the respective tabs together, and installing the connected electrode layers in a housing.

In addition to one or more of the features described herein, the first electrode layer is a first subset of the plurality of electrode layers, the first subset having a first group of tabs, and the another electrode layer is a second subset of the plurality of electrode layers, the second subset having a second group of tabs, where the respective tabs are formed so that the first group of tabs is offset from the second group of tabs.

In addition to one or more of the features described herein, electrically connecting the plurality of electrode layers includes stacking the first group of tabs as a first tab stack, stacking the second group of tabs as a second tab stack, welding the first tab stack by a single weld and welding the second tab stack as another single weld.

In addition to one or more of the features described herein, the first tab overlaps the another tab.

In addition to one or more of the features described herein, the first tab and the another tab are part of a group of tabs, each of the group of tabs successively offset to form a continuous tab.

In addition to one or more of the features described herein, the first tab is offset by forming the first tab so that the first tab is located at a first distance from a side of the first tab, and the another tab is located at a second distance from a side of the another tab, the first distance being different than the second distance.

In addition to one or more of the features described herein, forming the respective tabs includes cutting a series of notches in the electrode material, the series of notches cut to define respective offset distances.

In addition to one or more of the features described herein, cutting the series of notches is performed by a translatable notching die.

In yet another exemplary embodiment, a vehicle system includes a battery assembly including a battery cell, the battery cell including a housing and an electrode assembly disposed in the housing, the electrode assembly including a plurality of electrode layers, each of the plurality of electrode layers having a respective tab configured to electrically connect the plurality of electrode layers to one another. A first electrode layer includes a first tab, the first tab being offset from another tab of another electrode layer.

In addition to one or more of the features described herein, the electrode assembly includes at least one of a plurality of anode layers and a plurality of cathode layers. Each of the plurality of anode layers has a respective anode tab configured to electrically connect the plurality of anode layers to one another, where a first anode layer includes a first anode tab, the first anode tab being offset from another anode tab of another anode layer. Each of the plurality of cathode layers has a respective cathode tab configured to electrically connect the plurality of cathode layers to one another, where a first cathode layer includes a first cathode tab, the first cathode tab being offset from another cathode tab of another cathode layer.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts an example of a prismatic battery cell;

FIG. 2 depicts two electrode layers having offset tabs, in accordance with an exemplary embodiment;

FIG. 3 is a side view of an electrode assembly including electrode layers electrically connected by a group of tabs in an offset configuration, in accordance with an exemplary embodiment;

FIG. 4 is a perspective view of the electrode assembly of FIG. 3;

FIG. 5 depicts a portion of a battery cell, in accordance with an exemplary embodiment;

FIG. 6 depicts a portion of a battery cell, in accordance with an exemplary embodiment;

FIG. 7 depicts a group of electrodes having overlapping tabs, in accordance with an exemplary embodiment;

FIG. 8 depicts a system for manufacturing a battery cell, in accordance with an exemplary embodiment;

FIG. 9 is a flow diagram of a method of manufacturing a battery cell, in accordance with an exemplary embodiment;

FIGS. 10A and 10B depict components of a manufacturing system, including a mechanical die for forming electrode tabs, and aspects of a method of manufacturing a battery cell, in accordance with an exemplary embodiment; and

FIG. 11 depicts a motor vehicle including a battery system, in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with one or more exemplary embodiments, methods, devices and systems are provided for facilitating attachment and electrical connection of electrodes (anodes and cathodes) in a battery cell. An embodiment of a battery cell includes electrodes disposed in a housing as multiple anode layers and multiple cathode layers. The layers may be sheets or foils made from conductive materials, and each layer includes a connection portion that allows layers to be stacked and welded. The connection portion may be referred to as a “connection tab” or simply “tab.” For example, a group of anode layers are electrically connected by welding respective anode tabs together as a “weld stack.” Cathode layers are similarly connected by welding cathode tabs.

To facilitate effective electrical connection and proper welding, in an embodiment, electrode layers are formed with respective tabs in an offset configuration, in which at least one tab is offset from at least one other tab when the electrode layers are stacked as part of a battery cell. For example, a group of anode layers (anodes) is configured so that a subset of tabs form a first tab stack that is offset or separated from another subset of tabs forming a second tab stack, allowing the tab stacks to be separately welded and reducing the width of the welds. The offset configuration may result in tabs that are fully separate, overlap or a combination thereof. Embodiments also include methods of manufacturing battery cells with tabs in offset configurations.

Embodiments described herein present numerous advantages and technical effects. The embodiments provide for an improved manufacturing process that facilitates proper attachment and electrical connection of electrode tabs. For example, by providing offset tabs as described herein, the number of layers in each weld stack can be reduced, which ensures high quality welds. In this way, any number of electrode layers can be connected while maintaining weld paths that are sufficiently short, so as to avoid the loss of weld quality that would otherwise occur as the number of tabs that are welded together increase.

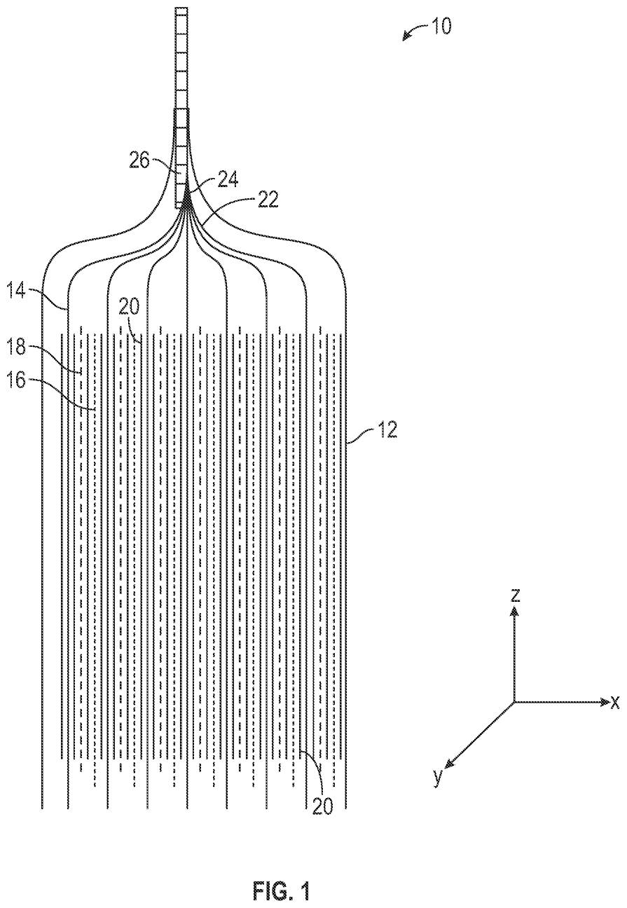

FIG. 1 depicts an example of a battery cell 10. The battery cell includes a housing 12, which may be a rigid housing (e.g., a drawn aluminum housing) that is sealed to enclose a plurality of electrodes. The housing 12 may be made from any suitable material. Embodiments described herein are not limited to any particular type of battery cell, or any particular shape, size or material of the electrodes and the housing. For example, embodiments may be applicable to pouch-type cells and other types of cells.

The battery cell 10 includes a plurality of negative electrodes or anode layers 14, and a plurality of positive electrodes or cathode layers 16. The anodes and cathodes are made from selected electrically conductive materials and configured as thin sheets or foils. A separator 18 made from an electrically insulating material (e.g., polymer or ceramic) is disposed between each anode 14 and adjacent cathode 16. An active material 20, such as a graphite or a material including Lithium, is disposed in the housing 12 between the various layers.

It is noted that the number of electrodes is not limited to the number shown in FIG. 1. The battery cell may have any number of anode layers 14 and any number of cathode layers 16. For example, a battery cell may have hundreds of individual foil layers forming the electrodes.

As shown in FIG. 1, each anode layer 14 includes a portion 22 that extends away from the interior of the cell 10 and allows for electrical connection of each anode layer 14 with another anode layer 14. This portion 22 is also referred to as a tab 22 or connection tab 22. Although not shown, the cathode layers 16 similarly include tabs so that the cathode layers 16 can be connected.

The tabs 22 (or a subset thereof) are stacked together as a tab stack 24. The tab stack 24 welds foils or tabs together by, for example, a primary ultrasonic weld. The weld may be a solid-state weld joint formed through ultrasonic welding or a fusion weld joint formed through laser welding, although other metal-to-metal joining procedures may be used.

The tab stack 24 may be attached to an electrically conductive connector 26. The connector 26 forms a negative terminal. The cathode layers 16 may be similarly welded to a positive terminal (not shown) that extends to an exterior of the housing 12.

As the number of tabs 22 increase, the quality of the weld can deteriorate, which can result in faulty electrical connections, suboptimal operation and damage to the cell 10 and/or other components connected to the cell 10.

In an embodiment, at least one tab 22 is positioned relative to its respective anode layer 14, so that the at least one tab 22 is offset as compared to at least one other tab 22. A first tab is “offset” from a second tab when the first and second tabs do not completely align when their respective electrode layers are stacked/aligned. For example, two tabs may be offset such that they are completely separate, or offset such that they overlap.

In an embodiment, the tabs 22 are positioned so that they define at least two individual foil stacks or tab stacks. In another embodiment, the tabs are positioned so that at least a subset of the tabs successively overlap to create relatively thin elongated stack (an “overlapping stack”).

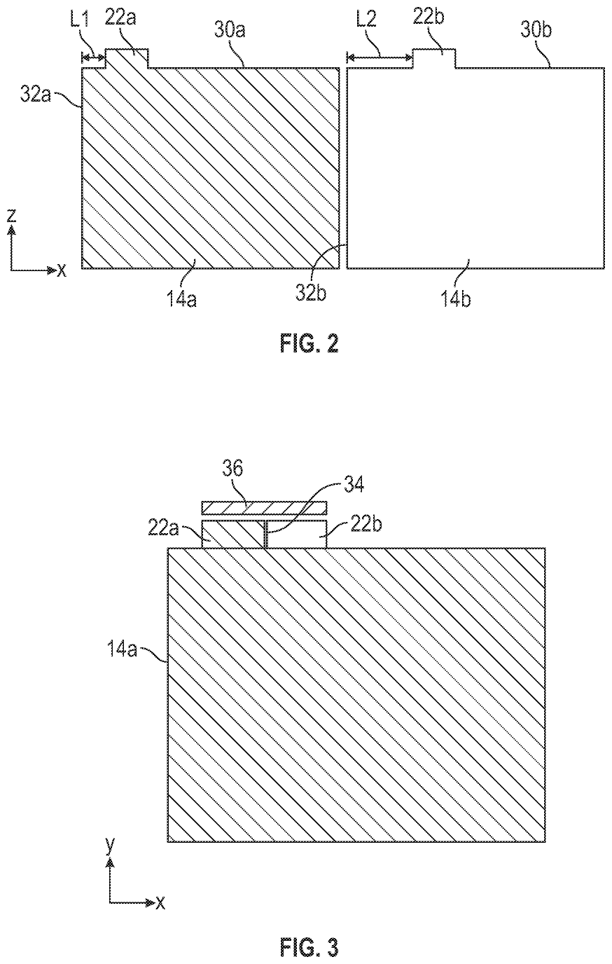

FIGS. 2-4 depict an embodiment of an offset configuration that can be used to establish multiple tab stacks and/or at least one offset stack or tab. This embodiment is described in conjunction with the anode layers 14 for illustration purposes, but is not so limited (e.g., a similar offset configuration can be provided for cathode layers 16).

In this embodiment, the tabs 22 are configured so that when the anode layers 14 are aligned, the tabs 22 define at least two separate tab stacks. For example, in FIG. 2, a first subset of tabs 22 (denoted as tabs 22a) are formed on a first subset of the anode layers 14 (denoted as anode layers 14a).

As shown in FIG. 2, an anode layer 14a has a tab 22a formed at an end 30a of the anode layer 14a. The tab 22a is offset from a side 32a of the anode layer 14a by a selected offset length L1 in a direction along the end 30a (an x-direction).

A tab 22b is formed at an end 30b of an anode layer 14b. The tab 22b is offset from a side 32b of the anode layer 14b by a selected offset length L2 in the x-direction, such that L1 and L2 are different lengths. These lengths can be selected so that the tab 22a is completely separate from the tab 22b (with respect to the x-direction), or so that the tab 22a overlaps the tab 22b in the x-direction.

For example, as shown in FIG. 3, the tab 22a is offset from the tab 22b so that the tab 22a is adjacent to the tab 22b. The lengths L1 and L2 may be selected so that a gap 34 is provided for tolerancing.

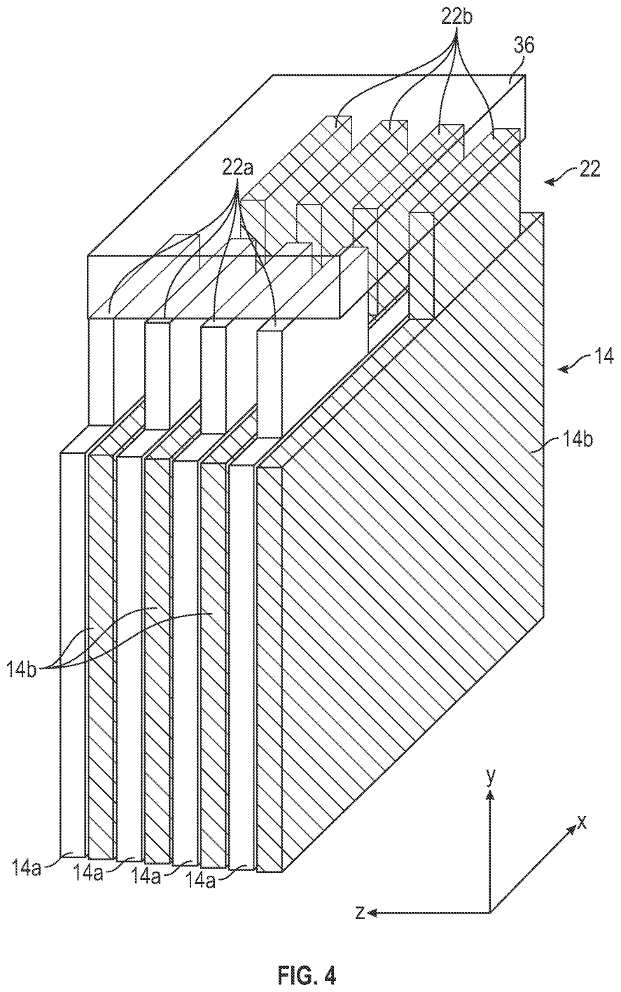

FIG. 4 shows the anode layers 14 with offset tabs when the tabs 22 have been stacked and welded together. As shown, the stack of tabs 22a are welded to a weld plate 36. The stack of tabs 22b are also welded to the weld plate 36. It is noted that both stacks can be welded in a single weld pass.

Thus, instead of a single foil stack or tab stack, the tabs 22a and the tabs 22b define two separate stacks. The width of the weld path is reduced by half, as each stack is half the width of a typical single stack, resulting in a higher quality weld.

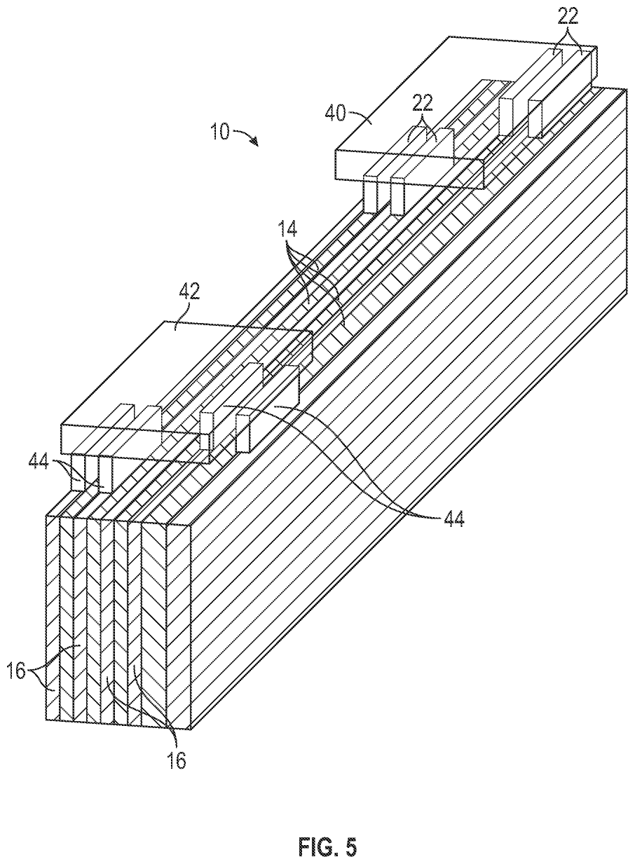

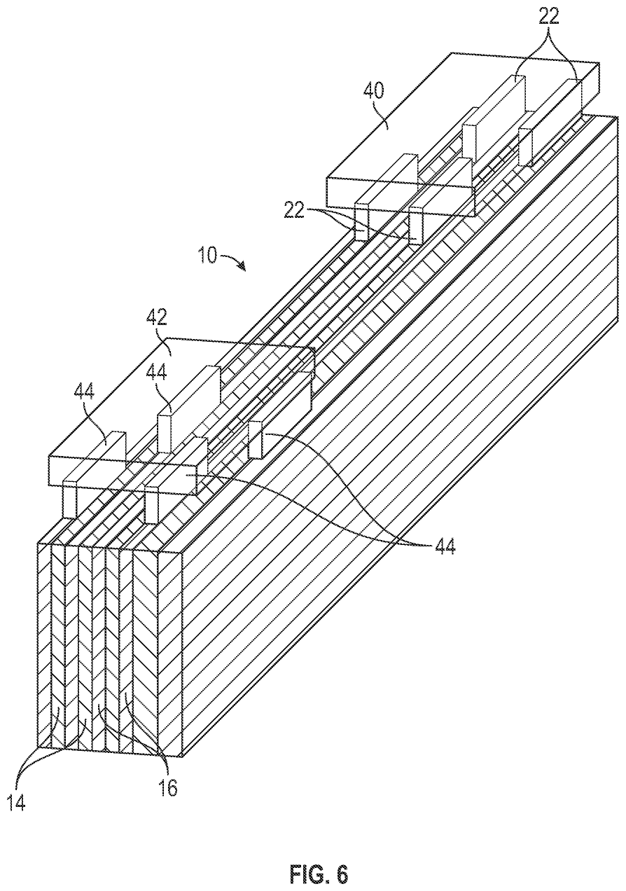

The various tabs can be offset to define any desired pattern. FIGS. 5 and 6 show examples of such patterns, which allow for the collection of tabs at various welding locations. A portion of the battery cell 10 is shown, including layers of the anode 14 and the cathode 16 (with separator layers, not shown).

The anode layers 14 are connected to each other via tabs 22, which are welded to an anode weld plate 40. The cathode layers 16 are connected to each other via tabs 44, which are welded to a cathode weld plate 42. The anode weld plate 40 and the cathode weld plate 42 may form respective anode and cathode terminals, or may be connected to other components to form the terminals.

FIG. 5 shows an example in which the offset pattern is selected so that groups of anode layers 14 or cathode layers 16 define separate stacks (where the tabs in each stack are at least substantially aligned). FIG. 6 shows an example in which the offset pattern is selected so that adjacent anode tabs 22 and adjacent cathode tabs 44 are offset and define an alternating pattern.

As noted above, the anode layers 14 may have one or more overlapping anode tabs 22, and the cathode layers 16 may have one or more overlapping cathode tabs 44. For example, some or all of the anode tabs 22 may overlap.

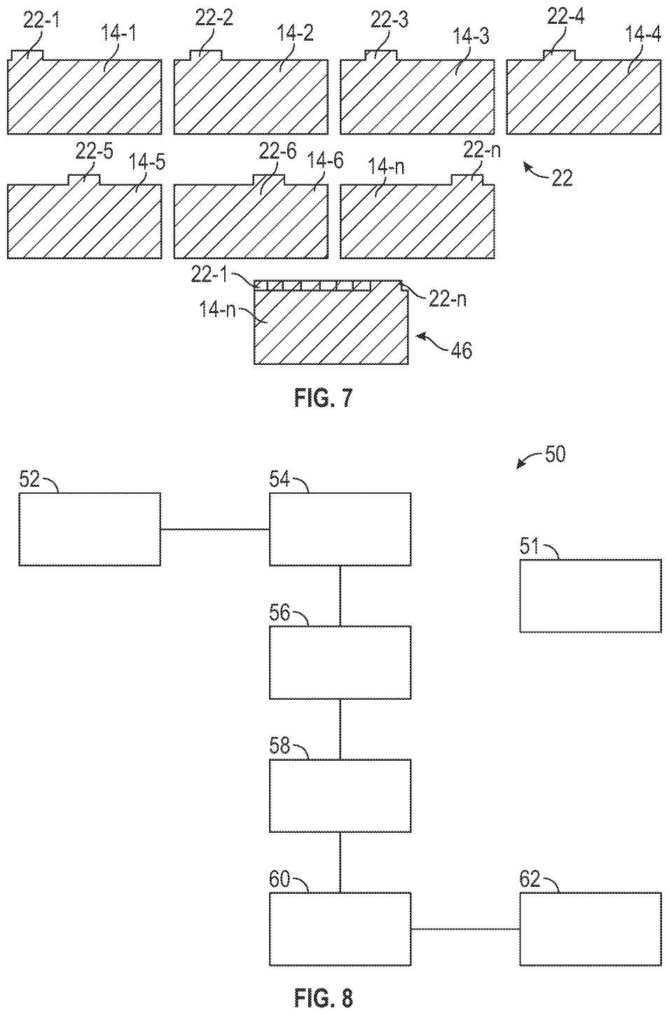

FIG. 7 shows an example of an overlapping tab configuration, in which a group of n tabs 22 successively overlap. In this example, seven anode layers are shown, denoted as anodes 14-1, 14-2, 14-3, 14-4, 14-5, 14-6 and 14-n. Each layer includes a respective tab, denoted as tabs 22-1, 22-2, 22-3, 22-4, 22-5, 22-6 and 22-n. This configuration may have any number of anodes and respective tabs.

The overlapping pattern may be achieved by cutting or otherwise forming the tabs so that each tab is formed with a successively longer offset length. As shown, when the anode layers are assembled as an anode stack 46, the tabs 22-1, 22-2, 22-3, 22-4, 22-5, 22-6 and 22-n form an overlapping pattern, which results in one relatively thin tab for the whole anode stack 46.

FIG. 8 depicts an example of a manufacturing system 50 for manufacturing battery cells. The manufacturing system 50 includes various manufacturing stations, which may be controlled or operated by a computer system, a human operator or a combination thereof, such as a controller 51. The controller 51 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The controller 51 may include a non-transitory computer-readable medium that stores instructions which, when processed by one or more processors of the controller 51, implements aspects of methods described herein.

As described herein, a “station” refers to any number, combination and layout of equipment and is not intended to limit the manufacturing system 50 to any specific machine or combination of machines.

The manufacturing system includes, for example, an active material processing station 52 for preparing active materials to be applied to the electrode. The system 50 may also include a coating station 54 for coating electrodes with the active materials.

The manufacturing system 52 also includes an electrode cutting station 56, which can be used to form tabs along electrode sheets, so that the tabs form offset patterns or configurations as described herein. Tabs may be formed in any suitable manner, such as by laser cutting, stamping, punching and others. In some cases, tabs may be formed by attaching tabs to the electrode sheets at desired locations. The cutting station 56 may include one or more cutting dies.

The system 50 may include other stations for performing subsequent processes to complete battery cells. Examples include a stacking station 58, a welding station 60, and an assembly station 62 (e.g., for cell packaging, sealing, electrolyte filling, etc.).

The manufacturing system 50 may include additional stations for manufacturing battery assembles, such as battery packs and/or modules. For example, a battery cell can be installed in a battery assembly. The battery assembly may be a battery module having a plurality of electrically connected battery cells, such as a battery module that is incorporated into a vehicle (e.g., an electric or hybrid vehicle) as part of a battery pack.

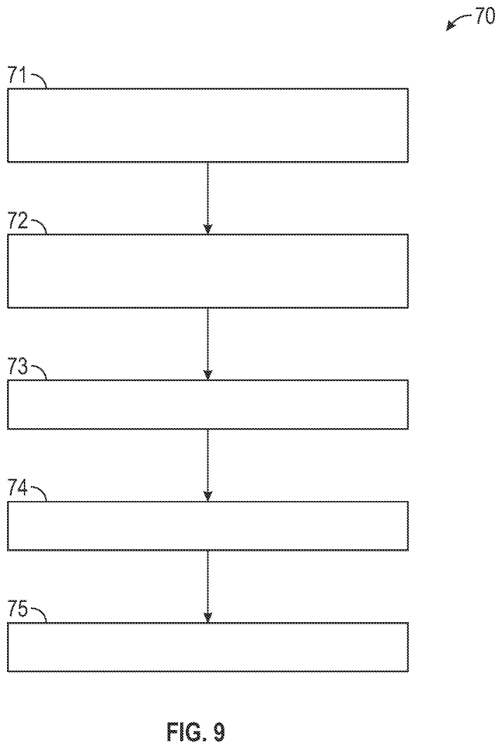

FIG. 9 illustrates embodiments of a method 70 of manufacturing a battery cell. The method 70 (or parts thereof) may be performed by any suitable processing device or devices, such as the controller 51 of the manufacturing system 50, but is not so limited.

The method 70 includes a number of steps or stages represented by blocks 71-75. The method 70 is not limited to the number or order of steps therein, as some steps represented by blocks 71-75 may be performed in a different order than that described below, or fewer than all of the steps may be performed.

At block 71, electrodes are created or acquired, which include anode sheets and cathode sheets made from a coated conductive material. For example, the anode sheets are made from copper, and the cathode sheets are made from aluminum.

At block 72, anode sheets are cut, trimmed or otherwise processed to create a series of anode tabs. Similarly, cathode sheets are processed to create a series of cathode tabs. The tabs are positioned so that they will have a desired offset pattern or configuration (as described herein) when the sheets are wrapped and/or stacked to construct a battery cell.

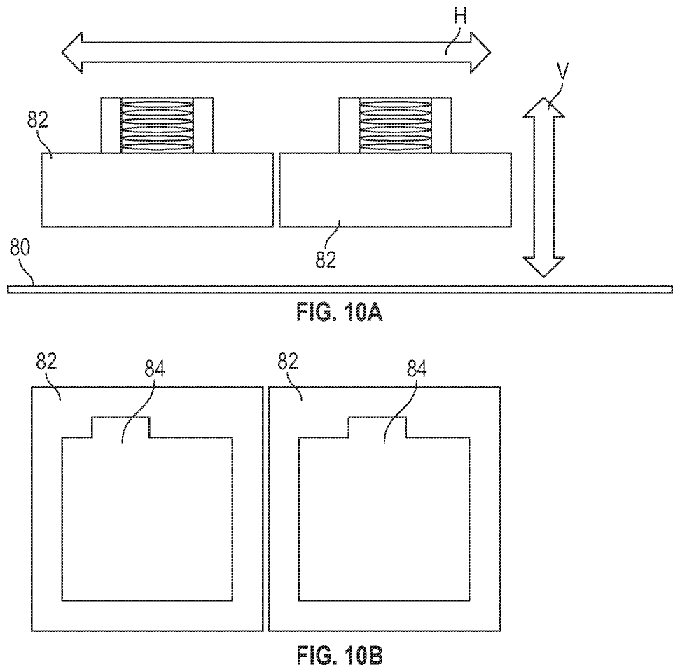

For example, as shown in FIGS. 10A and 10B, a sheet 80 of a coated electrode material (anode or cathode material) is fed via conveyor belt (or other suitable device) to the cutting station 56. A mechanical die 82, referred to as a notching die, is disposed above the sheet 80 and can be translated in a vertical direction (denoted by arrow V) and in a horizontal direction (denoted by arrow H). FIG. 10A shows a front view of the notching die 82, and FIG. 10B shows a bottom view of the notching die 82.

As the sheet 80 is moved under the notching die 82, the notching die 82 is moved horizontally to a desired position in order to cut a notch in the sheet 80 at a desired location, so as to define a tab at a desired offset length. FIG. 10A shows two examples of positions of the notching die 82, and FIG. 10B shows the corresponding locations 84 of a notch formed at each position.

At block 73, the anode sheets and cathode sheets, with their respective tabs, are stacked or otherwise assembled with separator layers. The tabs of anode layers are electrically connected via welding as discussed above, and the tabs of cathode layers are similarly connected.

At block 74, additional steps are performed to complete assembly of the battery cell, such as installing the welded electrodes in a housing (e.g., a prismatic housing) with separator layers, quality inspection, electrolyte filling, housing sealing and others.

At block 75, the battery cell may be installed in a battery assembly, such as a battery pack or battery module. For example, the battery cell is installed in a battery module with other cells, and the battery module is installed in an electric or hybrid vehicle.

It is noted that the manufacturing system 50 and method 70 are not intended to limit embodiments to any specific manufacturing process. Any suitable manufacturing system or process that includes some form of cell tab creation and electrical connection may be used.

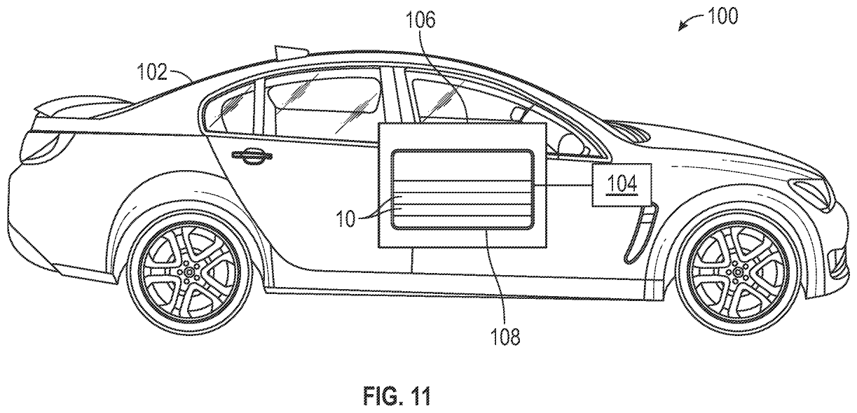

As noted herein, battery cells including offset tabs as described herein may be part of a vehicle battery system. FIG. 11 shows an embodiment of a motor vehicle 100, which includes a vehicle body 102. The vehicle 100 may be a combustion engine vehicle, an electrically powered vehicle (EV) or a hybrid electric vehicle (HEV). In an example, the vehicle 100 is a hybrid or electric vehicle having an electric motor 104. A battery system 106 is electrically connected to the motor 104 and/or other components, such as vehicle electronics. The battery system 106 includes one or more modules 108 forming part of a battery pack (not shown), where each module 108 includes a plurality of battery cells 10.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A battery cell, comprising:
a housing enclosing an anode and a cathode; and
an electrode assembly disposed in the housing, the electrode assembly including a plurality of electrode layers, each of the plurality of electrode layers having a respective tab configured to electrically connect the plurality of electrode layers to one another, wherein a first electrode layer includes a first tab, the first tab being offset from another tab of another electrode layer.

2. The battery cell of claim 1, wherein the electrode assembly includes at least one of:
a plurality of anode layers, each of the plurality of anode layers having a respective anode tab configured to electrically connect the plurality of anode layers to one another, wherein a first anode layer includes a first anode tab, the first anode tab being offset from another anode tab of another anode layer; and
a plurality of cathode layers, each of the plurality of cathode layers having a respective cathode tab configured to electrically connect the plurality of cathode layers to one another, wherein a first cathode layer includes a first cathode tab, the first cathode tab being offset from another cathode tab of another cathode layer.

3. The battery cell of claim 1, wherein the first electrode layer is a first subset of the plurality of electrode layers, the first subset having a first group of tabs, and the another electrode layer is a second subset of the plurality of electrode layers, the second subset having a second group of tabs, wherein the first group of tabs is offset from the second group of tabs.

4. The battery cell of claim 3, wherein the first group of tabs and the second group of tabs each define an individual tab stack, each individual tab stack configured to be welded together by a single weld.

5. The battery cell of claim 1, wherein the respective tabs of the plurality of electrode layers are arranged in an alternating pattern.

6. The battery cell of claim 1, wherein the first tab overlaps the another tab.

7. The battery cell of claim 6, wherein the first tab and the another tab are part of a group of tabs, each of the group of tabs successively offset to form a continuous tab.

8. The battery cell of claim 1, wherein the first tab is offset by forming the first tab so that the first tab is located at a first distance from a side of the first tab, and the another tab is located at a second distance from a side of the another tab, the first distance being different than the second distance.

9. The battery cell of claim 1, wherein the battery cell is configured to be installed in a battery assembly having a plurality of battery cells.

10. The battery cell of claim 9, wherein the battery assembly is configured to be disposed in a vehicle to supply power for propulsion of the vehicle.

11. A method of manufacturing a battery cell, comprising:
acquiring an electrode material;
creating a plurality of electrode layers from the electrode material, wherein the creating includes forming a respective tab for each electrode layer, wherein a first electrode layer is formed with a first tab, the first tab being offset from another tab of another electrode layer;
electrically connecting the plurality of electrode layers by welding the respective tabs together; and
installing the connected electrode layers in a housing.

12. The method of claim 11, wherein the first electrode layer is a first subset of the plurality of electrode layers, the first subset having a first group of tabs, and the another electrode layer is a second subset of the plurality of electrode layers, the second subset having a second group of tabs, wherein the respective tabs are formed so that the first group of tabs is offset from the second group of tabs.

13. The method of claim 12, wherein electrically connecting the plurality of electrode layers includes stacking the first group of tabs as a first tab stack, stacking the second group of tabs as a second tab stack, welding the first tab stack by a single weld and welding the second tab stack as another single weld.

14. The method of claim 11, wherein the first tab overlaps the another tab.

15. The method of claim 14, wherein the first tab and the another tab are part of a group of tabs, each of the group of tabs successively offset to form a continuous tab.

16. The method of claim 11, wherein the first tab is offset by forming the first tab so that the first tab is located at a first distance from a side of the first tab, and the another tab is located at a second distance from a side of the another tab, the first distance being different than the second distance.

17. The method of claim 16, wherein forming the respective tabs includes cutting a series of notches in the electrode material, the series of notches cut to define respective offset distances.

18. The method of claim 17, wherein cutting the series of notches is performed by a translatable notching die.

19. A vehicle system comprising:
a battery assembly including a battery cell, the battery cell including a housing and an electrode assembly disposed in the housing, the electrode assembly including a plurality of electrode layers, each of the plurality of electrode layers having a respective tab configured to electrically connect the plurality of electrode layers to one another, wherein a first electrode layer includes a first tab, the first tab being offset from another tab of another electrode layer.

20. The vehicle system of claim 19, wherein the electrode assembly includes at least one of:
a plurality of anode layers, each of the plurality of anode layers having a respective anode tab configured to electrically connect the plurality of anode layers to one another, wherein a first anode layer includes a first anode tab, the first anode tab being offset from another anode tab of another anode layer; and
a plurality of cathode layers, each of the plurality of cathode layers having a respective cathode tab configured to electrically connect the plurality of cathode layers to one another, wherein a first cathode layer includes a first cathode tab, the first cathode tab being offset from another cathode tab of another cathode layer.
